(19) United States
(12) Patent Application Publication
(10) Pub. No.: US 2003/0031459 A1
(43) Pub. Date: Feb. 13, 2003

(54) Program receiver and accumulation broadcast charging device

(76) Inventors: Hiroyuki Nishi, Tokyo (JP); Hidekazu Tanigawa, Hirakata (JP); Ryuhei Akiyama, Nishinomiya (JP); Hiroki Maeda, Toyonaka (JP)

Correspondence Address: SNELL & WILMER, ONE ARIZONA CENTER, 400 EAST VAN BUREN, PHOENIX, AZ, 850040001

(21) Appl. No.: 10/220,630

(22) PCT Filed: Mar. 5, 2001
(86) PCT No.: PCT/JP01/01703

(30) Foreign Application Priority Data
Mar. 3, 2000 (JP) 2000-059419

(51) Int. Cl. H04N 5/76; H04N 7/00

(52) U.S. Cl. 386/46; 386/83

(57) ABSTRACT

A program receiving apparatus comprises a receiving section for receiving programs and program attributes indicating attributes of the programs, a program memory section for holding memory regions corresponding to the program attributes and memorizing the programs in the memory regions, and a storage control section for storing the programs received by the receiving section in the memory regions of the program memory section corresponding to the program attributes received by the receiving section.

### TECHNICAL FIELD

The present invention relates to a program receiving apparatus and a storage broadcast charging apparatus. More particularly, the present invention relates to a program receiving apparatus and a storage broadcast charging apparatus which utilize the contents of a stored program.

### BACKGROUND ART

A receiving apparatus for storing the contents of a broadcasted program stores program contents, as long as a user storage region in a storage device in the receiving apparatus is empty. For example, a receiving apparatus having a video apparatus, such as D-VHS, stores program contents as long as a user storage region is empty.

A known technique in which a user storage region of a storage device is divided into several regions in advance for an information apparatus, such as a personal computer. An example of such an information apparatus is VAIO.

However, the above-described receiving apparatus which stores broadcasted program contents has the following problems.

Firstly, for example, in a receiving apparatus having a video apparatus, program contents are stored by a method of designating recording times so that storage regions are allocated to the program contents in order of time when they are stored from the earliest onwards.

Therefore, when program contents, other than the program contents which a user most preferably wants to store, are stored earlier, so that a storage region becomes insufficient, the program contents which the user most preferably wants to store cannot be stored.

Secondly, in order to receive a storage broadcast service, a predetermined dedicated region is required for a receiving apparatus in addition to the storage device of a receiving apparatus. Therefore, reception of a plurality of storage broadcast services would require a storage device having a very large storage region, leading to an increase in the cost of the receiving apparatus. A user has to bear a considerably high expense for purchase of such a receiving apparatus having an increased cost.

An object of the present invention is to provide a program receiving apparatus capable of ensuring that program contents which a user most preferably wants to store are stored.

Another object of the present invention is to provide a program receiving apparatus and a storage broadcast charging apparatus capable of receiving a storage broadcast service without a user bearing a large expense.

### DISCLOSURE OF THE INVENTION

A program receiving apparatus according to the present invention comprises a receiving section for receiving programs and program attributes indicating attributes of the programs, a program memory section for holding memory regions corresponding to the program attributes and memorizing the programs in the memory regions, and a storage control section for storing the programs received by the receiving section in the memory regions of the program memory section corresponding to the program attribute received by the receiving section. Thereby, the above-described objects are achieved.

The program receiving apparatus may further comprises a memory region detecting section for detecting that the memory regions corresponding to the program attributes are allocated, and an allocation information transmitting section for, when the memory region detecting section detects that a memory region corresponding to a specific program attribute is allocated, transmitting allocation information indicating the allocation.

The program receiving apparatus may further comprises a capacity managing section for managing capacities of the memory regions corresponding to the program attributes, a capacity obtaining section for obtaining the capacities managed by the capacity managing section, and a capacity information transmitting section for transmitting capacity information having a set of the program attributes and the capacities.

The program receiving apparatus may further comprises a memory region setting section for setting the memory region of each of the program attributes in the program memory section.

A storage broadcast charging apparatus according to the present invention comprises a transmitting end information receiving section for receiving transmitting end information having capacity information and a transmitting end identifier for identifying a transmitting end for the capacity information, and a refund calculating section for calculating a fund which should be paid back to the transmitting end identified with the transmitting end identifier contained in the transmitting end information using the capacity information contained in the transmitting end information as a parameter. Thereby, the above-described objects are achieved.

### BRIEF DESCRIPTION OF THE DRAWINGS

FIG. 1 is a block diagram for explaining a program receiving apparatus according to an embodiment of the present invention.

FIG. 2 is a diagram for explaining program contents and a program attribute according to the embodiment.

FIG. 3 is a diagram for explaining a screen for setting a memory region for each program attribute in a program memory section.

FIG. 4 is a diagram for explaining a program attribute table according to the embodiment.

FIG. 5 is a diagram for explaining another screen for setting a memory region for each program attribute in a program memory section.

FIG. 6 is a diagram for explaining another program attribute table according to the embodiment.

FIG. 7 is a diagram for explaining another screen for setting a memory region for each program attribute in a program memory section according to the embodiment.

FIG. 8 is a diagram for explaining another program attribute table according to the embodiment.

FIG. 9 is a flowchart of an operation of a program receiving apparatus according to the embodiment for storing program contents.

FIG. 10 is a flowchart of an operation of the program receiving apparatus according to the embodiment for transmitting allocation information.

FIG. 11 is a flowchart of an operation of the program receiving apparatus according to the embodiment for transmitting capacity information.

FIG. 12 is a block diagram for explaining a storage broadcast charging apparatus according to an embodiment of the present invention.

FIG. 13 is a diagram for explaining a refund calculation table according to an embodiment of the present invention.

FIG. 14 is a flowchart showing an operation of the storage broadcast charging apparatus according to the embodiment.

### BEST MODE FOR CARRYING OUT THE INVENTION

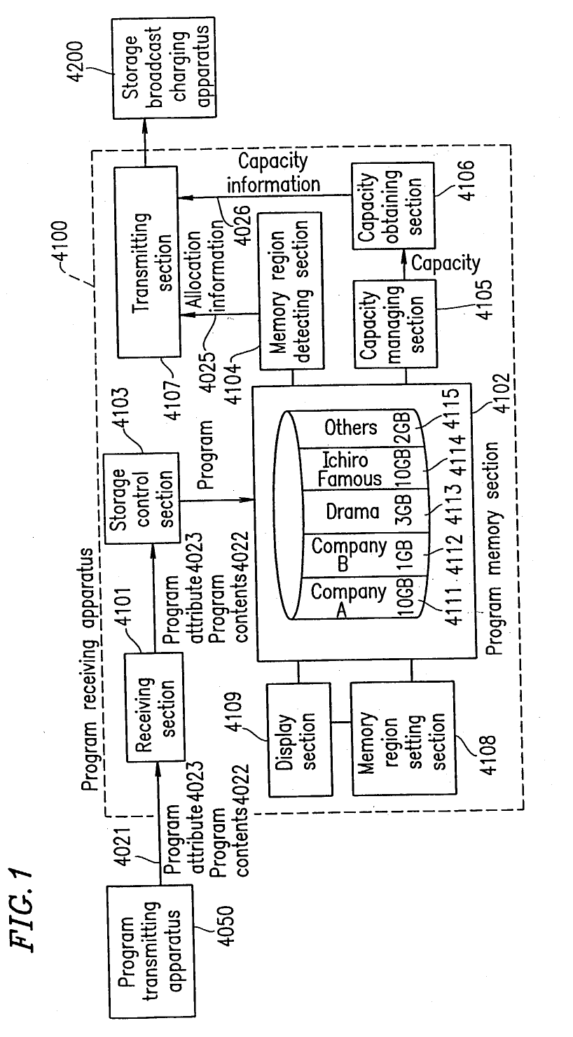

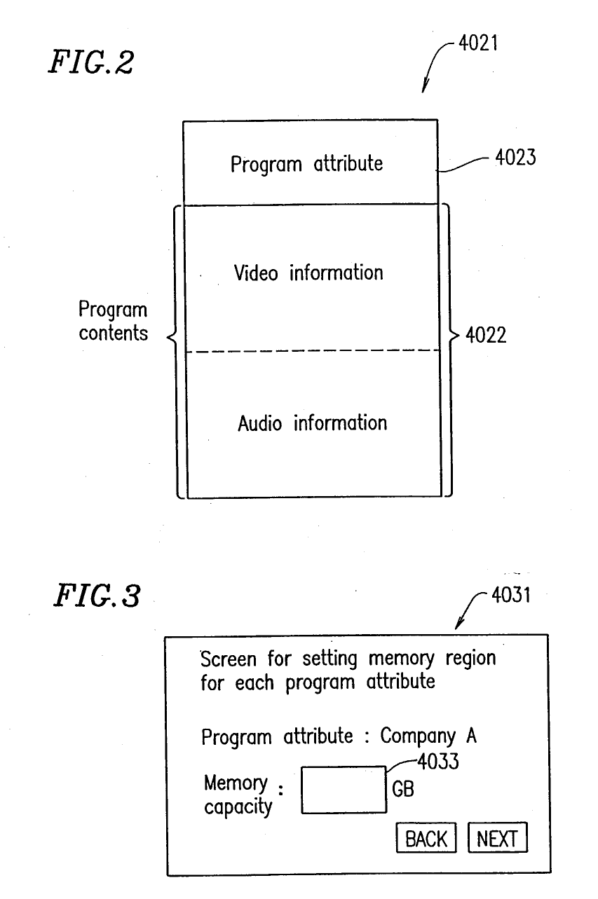

FIG. 1 is a block diagram for explaining a program receiving apparatus 4100 according to an embodiment of the present invention. FIG. 2 is a diagram for explaining program contents 4022 and a program attribute 4023 according to the embodiment. The program receiving apparatus 4100 comprises a receiving section 4101, a program memory section 4102, a storage control section 4103, a memory region detecting section 4104, a capacity managing section 4105, a capacity obtaining section 4106, a transmitting section 4107, a memory region setting section 4108, and a display section 4109.

The receiving section 4101 receives a program 4021 from a program transmitting apparatus 4050. As shown in FIG. 2, the program 4021 contains the program contents 4022 and the program attribute 4023. The program contents 4022 contain video information and audio information. The receiving section 4101 may comprise a tuner and a separation circuit, for example.

The program memory section 4102 holds memory regions 4111, 4112, 4113, 4114 and 4115 corresponding to the program attribute 4023 and memorizing the program 4021 into the memory regions 4111, 4112, 4113, 4114 and 4115. The program memory section 4102 may be a memory medium, such as a hard disk and a DVD-RAM.

The storage control section 4103 stores the program 4021 received by the receiving section 4101 into a memory region in the program memory section 4102 corresponding to the program attribute 4023 received by the receiving section 4101. The memory region detecting section 4104 detects that the memory region, corresponding to the program attribute 4023, has been allocated. The capacity managing section 4105 manages the capacity of the memory region corresponding to the program attribute 4023. The capacity obtaining section 4106 obtains capacity managed by the capacity managing section 4105.

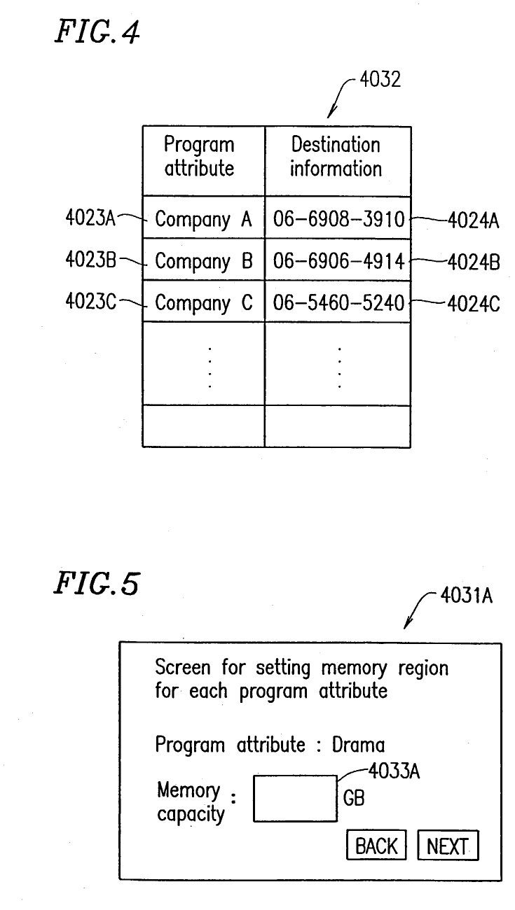

FIG. 3 is a diagram for explaining a screen 4031 for setting a memory region for each program attribute 4023 in the program memory section 4102 according to the embodiment. FIG. 4 is a diagram for explaining a program attribute table 4032 according to the embodiment.

The memory region setting section 4108 sets a memory region for each program attribute 4023 in the program memory section 4102. The memory region setting section 4108 has the program attribute table 4032. The memory region setting section 4108 displays, on the display section 4109, the screen 4031 for setting a memory region for each program attribute 4023 in the program memory section 4102, based on the program attribute table 4032. The screen 4031 may be changed to a screen for inputting the value of memory capacity for other program attributes.

The program attribute table 4032 contains at least one program attribute. In the example shown in FIG. 4, the program attribute table 4032 contains program attributes 4023A, 4023B, 4023C, . . . . The program attribute 4023A may be company A. The program attribute 4023B may be company B. The program attribute 4023C may be company C.

The program attribute table 4032 may contain destination information 4024A, 4024B, 4024C, . . . corresponding to the program attributes 4023A, 4023B, 4023C, . . . . For example, the destination information 4024A may be a point of contact of company A (e.g., a telephone number). The destination information 4024A may be a mail address or a fax number.

When a user inputs the value of memory capacity for company A into a memory capacity input region 4033 on the screen 4031, the memory region setting section 4108 sets the memory region 4111 corresponding to the program attribute 4023A indicating company A. For example, when the user inputs 10 GB, the memory region setting section 4108 sets the memory region 4111 of 10 GB.

When the screen 4031 is changed to a screen for inputting the value of memory capacity for company B and then a user inputs the value of memory capacity for company B, the memory region setting section 4108 sets the memory region 4112 corresponding to the program attribute 4023B indicating company B. For example, when the user inputs 1 GB, the memory region setting section 4108 sets the memory region 4112 of 1 GB.

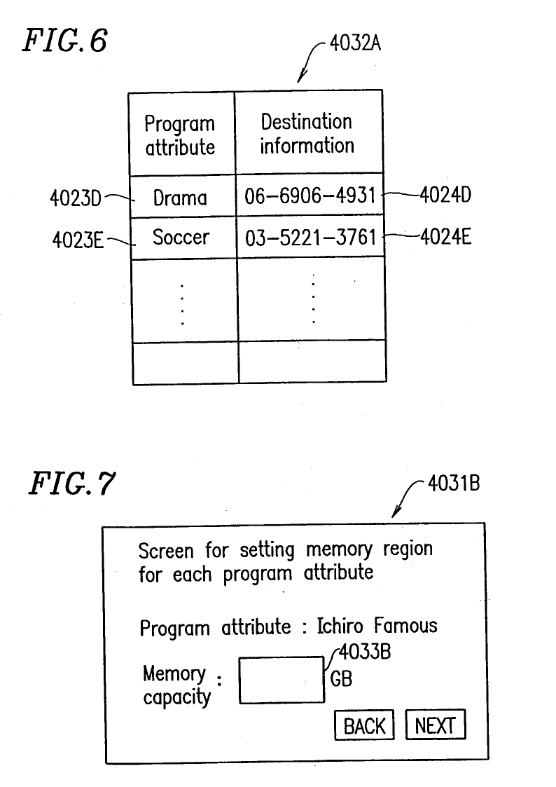

FIG. 5 is a diagram for explaining another screen 4031A for setting a memory region for each program attribute 4023 in the program memory section 4102. FIG. 6 is a diagram for explaining another program attribute table 4032A according to the embodiment.

The memory region setting section 4108 has the program attribute table 4032A. In the example shown in FIG. 6, the program attribute table 4032A contains program attributes 4023D, 4023E, . . . . The program attribute 4023D may be a drama. The program attribute 4023E may be soccer. Destination information 4024D may be a point of contact of a company which produces the drama of the program attribute 4023D (e.g., a telephone number). The destination information 4024D may be a mail address or a fax number.

When a user inputs the value of memory capacity for the drama into a memory capacity input region 4033A on the screen 4031A, the memory region setting section 4108 sets the memory region 4113 corresponding to the program attribute 4023D indicating the drama. For example, the user inputs 3 GB, the memory region setting section 4108 sets the memory region 4113 of 3 GB.

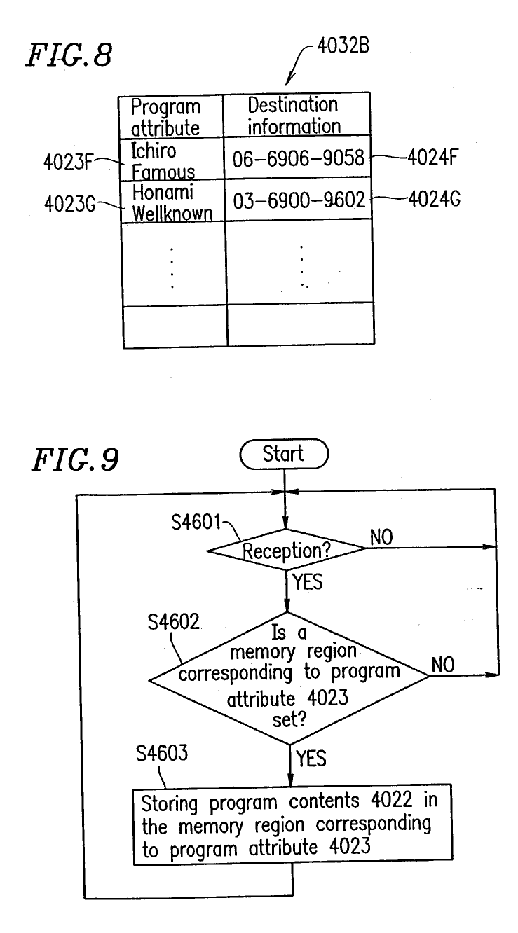

FIG. 7 is a diagram for explaining another screen 4031B for setting a memory region for each program attribute 4023 in the program memory section 4102. FIG. 8 is a diagram for explaining another program attribute table 4032B according to the embodiment.

The memory region setting section 4108 has the program attribute table 4032B. In the example shown in FIG. 8, the program attribute table 4032B contains program attributes 4023F, 4023G, . . . . The program attribute 4023F maybe the name of a first famous person (e.g., Ichiro Famous). The program attribute 4023G may be the name of a second famous person (e.g., Honami Wellknown). Destination information 4024F may be a point of contact of an agency, to which the first famous person belongs, of the program attribute 4023F (e.g., a telephone number). The destination information 4024F may be a mail address or a fax number.

When a user inputs the value of memory capacity for “Ichiro Famous” into the memory capacity input region 4033A on the screen 4031B, the memory region setting section 4108 sets the memory region 4114 corresponding to the program attribute 4023F indicating “Ichiro Famous”. For example, the user inputs 25 GB, the memory region setting section 4108 sets the memory region 4114 of 25 GB.

Thus, the memory region setting section 4108 sets the memory regions 4111, 4112, 4113 and 4114 for the respective program attributes 4023 in the program memory section 4102.

Note that the memory region setting section 4108 may set the memory region 4115 for storing a program having another program attribute. For example, if the memory region 4115 for storing a program having another program attribute is set, a program having a program attribute other than the program attribute 4023A indicating company A, the program attribute 4023B indicating company B, the program attribute 4023D indicating the drama, and the program attribute 4023F indicating “Ichiro Famous”, is stored in the memory region 4115.

The memory regions 4111, 4112, 4113, 4114, and 4115 may be prioritized. For example, if the priority of the memory region 4111 is set to be higher than the priority of the memory region 4113, when the program 4021 containing both the program attribute 4023A indicating company A and the program attribute 4023D indicating the drama is received, the program 4021 is stored in the memory region 4111 having priority higher than that of the memory region 4113.

Further, a multiple attribute memory region corresponding to a plurality of program attributes may be set. For example, when a multiple attribute memory region corresponding to both the program attribute 4023A indicating company A and the program attribute 4023D indicating the drama is set, only a program containing both the program attribute 4023A indicating company A and the program attribute 4023D indicating the drama is stored in the multiple attribute memory region. If a multiple attribute region corresponding to both the program attribute 4023B indicating company B and the program attribute 4023G indicating “Honami Wellknown” which is the name of a famous person is set, only a program containing both the program attribute 4023B indicating company B and the program attribute 4023G indicating “Honami Wellknown” is stored in the multiple attribute memory region.

FIG. 9 is a flowchart of an operation of the program receiving apparatus 4100 according to the embodiment of the present invention for storing the program contents 4022.

The receiving section 4101 judges whether or not the program 4021 has been received from the program transmitting apparatus 4050 (S4601). When the receiving section 4101 judges that the program 4021 has been received from the program transmitting apparatus 4050, the storage control section 4103 judges whether or not a memory region corresponding to the program attribute 4023 contained in the program 4021 has been set in the program memory section 4102 (S4602).

When the storage control section 4103 judges that a memory region corresponding to the program attribute 4023 contained in the program 4021 has been set in the program memory section 4102, the storage control section 4103 stores the program contents 4022 contained in the program 4021 in the memory region corresponding to the program attribute 4023 (S4603).

For example, in the example shown in FIG. 1, when the program attribute 4023 indicates company A, the memory region 4111 indicating company A has been set in the program memory section 4102. Therefore, the storage control section 4103 stores the program contents 4022 in the memory region 4111 corresponding to the program attribute 4023 indicating company A.

When the receiving section 4101 judges that the program 4021 has not been received from the program transmitting apparatus 4050 (NO in S4601), the storage control section 4103 judges that a memory region corresponding to the program attribute 4023 has not been set in the program memory section 4102 (NO in S4602), or the storage control section 4103 stores the program contents 4022 in a memory region corresponding to the program attribute 4023 (S4603), the process returns to S4601.

As described above, according to this embodiment, the memory regions 4111, 4112, 4113 and 4114 corresponding to program attributes which a user wants to store are set in the program memory section 4102 in advance, only the program contents 4022 having the program attributes which the user wants to store are stored in the program memory section 4102. Therefore, the program contents 4022 which the user wants to store can be reliably stored.

Note that the memory regions may be prioritized.

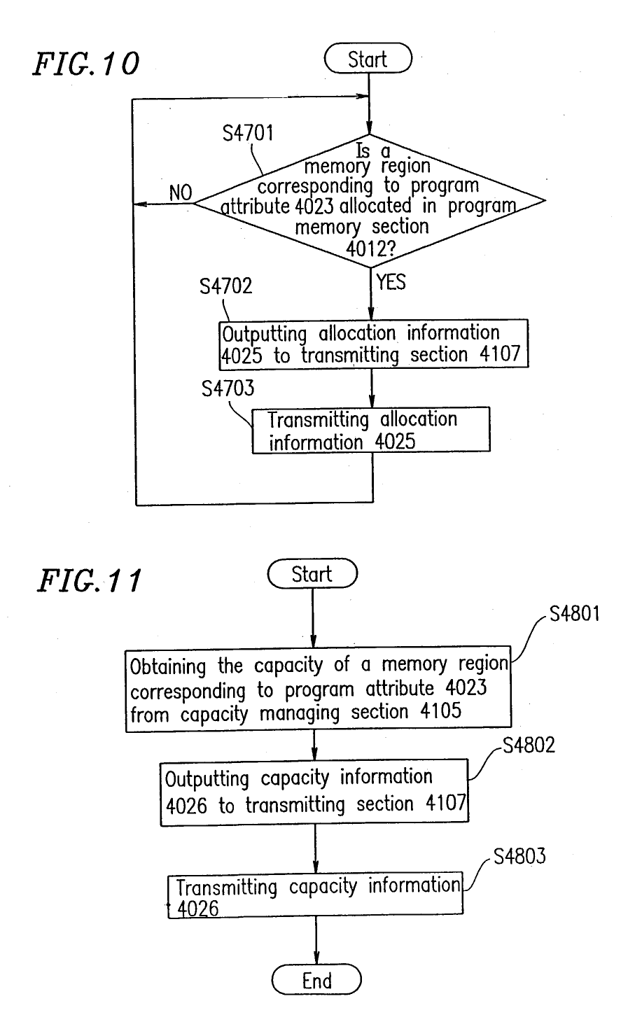

FIG. 10 is a flowchart of an operation of the program receiving apparatus 4100 according to the embodiment for transmitting allocation information.

The memory region detecting section 4104 judges whether or not a memory region corresponding to the program attribute 4023 has been allocated in the program memory section 4102 (S4701). When detecting that a memory region corresponding to the program attribute 4023 has been allocated in the program memory section 4102, the memory region detecting section 4104 outputs allocation information 4025 indicating that the memory region corresponding to the program attribute 4023 has been allocated in the program memory section 4102, to the transmitting section 4107 (S4702).

For example, when detecting that the memory region 4111 corresponding to the program attribute 4023A indicating company A has been allocated in the program memory section 4102, the memory region detecting section 4104 outputs allocation information 4025A indicating that the memory region 4111 corresponding to the program attribute 4023A indicating company A has been allocated in the program memory section 4102, to the transmitting section 4107. The allocation information 4025A contains information indicating company A.

When receiving the allocation information 4025 from the memory region detecting section 4104, the transmitting section 4107 transmits the allocation information 4025 to a storage broadcast charging apparatus 4200 (S4703). The transmitting section 4107 may store the allocation information received from the memory region detecting section 4104 in a buffer (not shown) and transmit the stored allocation information at predetermined timing (e.g., periodically).

When the memory region detecting section 4104 does not detect that a memory region corresponding to the program attribute 4023 has been allocated in the program memory section 4102 (No in S4701), or when the transmitting section 4107 transmits the allocation information 4025 to the storage broadcast charging apparatus 4200 (S4703), the process returns to S4701.

FIG. 11 is a flowchart of an operation of the program receiving apparatus 4100 of the embodiment transmitting capacity information. The capacity managing section 4105 manages the capacities of the memory regions 4111, 4112, 4113 and 4114 corresponding to the respective program attributes 4023, which are set by the memory region setting section 4108.

For example, in the example shown in FIG. 1, the capacity managing section 4105 manages the capacity (10 GB) of the memory region 4111 corresponding to the program attribute 4023A, the capacity (1 GB) of the memory region 4112 corresponding to the program attribute 4023B, the capacity (3 GB) of the memory region 4113 corresponding to the program attribute 4023D, and the capacity (25 GB) of the memory region 4114 corresponding to the program attribute 4023F.

The capacity obtaining section 4106 obtains the program attributes 4023 and the capacities of the memory regions 4111, 4112, 4113 and 4114 corresponding to the respective program attributes 4023 from the capacity managing section 4105 (S4801). The capacity obtaining section 4106 outputs capacity information 4026 having a set of the program attributes 4023 and the capacities to the transmitting section 4107 (S4802).

For example, in the example shown in FIG. 1, the capacity information 4026 contains a set of the program attribute 4023A indicating company A and the capacity of 10 GB, a set of the program attribute 4023B indicating company B and the capacity of 1 GB, a set of the program attribute 4023D indicating the drama and the capacity of 3 GB, and a set of the program attribute 4023F indicating “Ichiro Famous” and the capacity of 25 GB. The transmitting section 4107 transmits the capacity information 4026 to the storage broadcast charging apparatus 4200 described below (S4803).

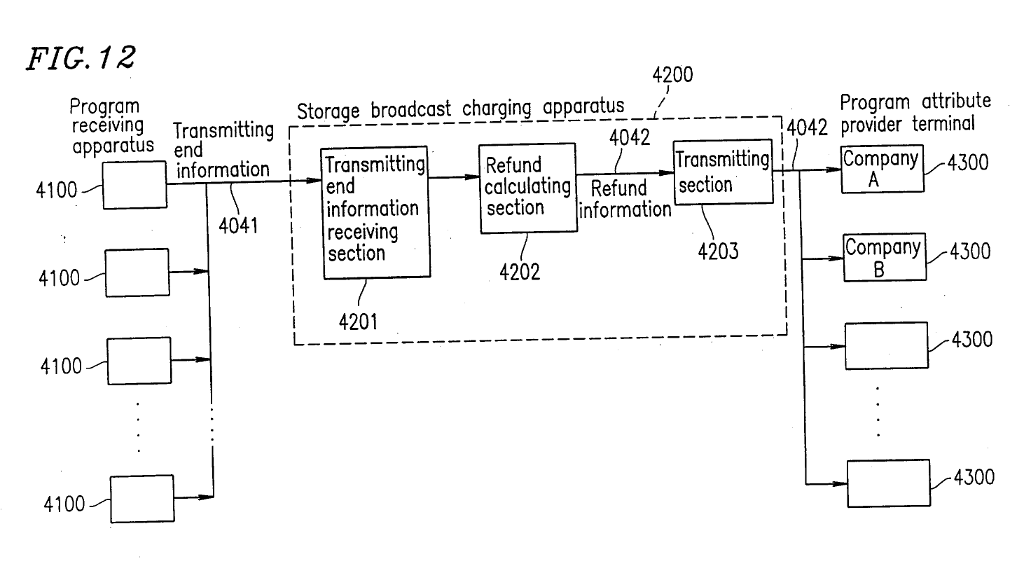

FIG. 12 is a block diagram for explaining the storage broadcast charging apparatus 4200 of the embodiment. The storage broadcast charging apparatus 4200 comprises a transmitting end information receiving section 4201, a refund calculating section 4202, and a transmitting section 4203.

The transmitting end information receiving section 4201 receives transmitting end information 4041 from the program receiving apparatus 4100. The transmitting end information 4041 has the program attribute 4023, the capacity information 4026, and transmitting end identifiers for identifying transmitting ends of the capacity information 4026 (FIG. 1). The transmitting end identifier may be, for example, a point of contact of a user of the program receiving apparatus 4100 (e.g., a telephone number). The transmitting end identifier may be a mail address or a fax number.

The refund calculating section 4202 calculates a refund, which should be paid back to a transmitting end identified by the identifier possessed by the transmitting end information 4041, based on the capacity information 4026 (FIG. 1) as a parameter.

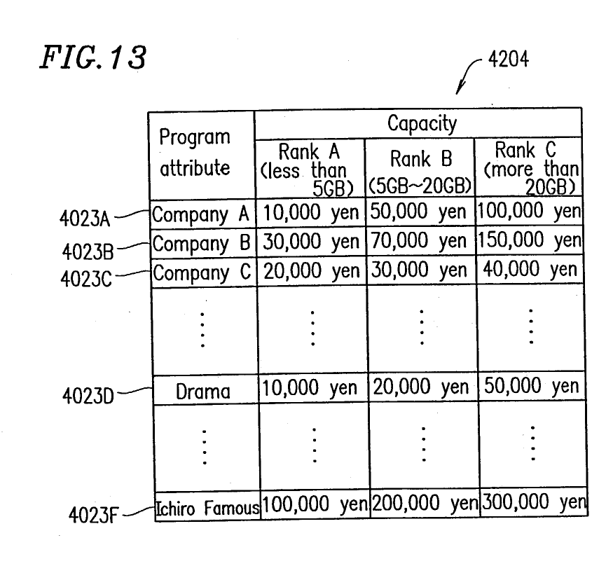

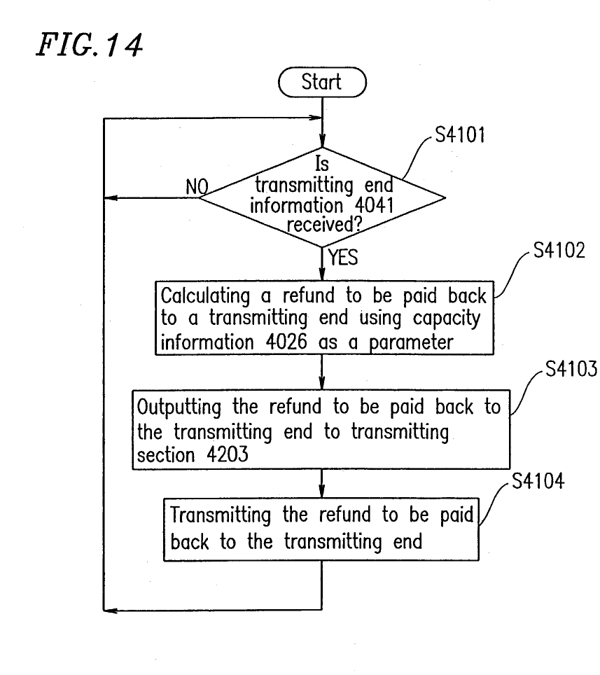

FIG. 13 is a diagram for explaining a refund calculation table 4204 according to the embodiment. FIG. 14 is a flowchart of an operation of the storage broadcast charging apparatus 4200 of the embodiment.

The transmitting end information receiving section 4201 judges whether or not the transmitting end information 4041 has been received from the program receiving apparatus 4100 (S4101). When the transmitting end information receiving section 4201 judges that the transmitting end information 4041 has been received from the program receiving apparatus 4100, the refund calculating section 4202 calculates a fund, which should be paid back to a transmitting end, based on the program attribute 4023, the capacity information 4026 and the refund calculation table 4204 (S4102).

For example, when the program attribute 4023 is the program attribute 4023A indicating company A and the capacity information 4026 indicates 10 GB, the refund calculation table 4204 shows that company A corresponds to rank B and the refund calculating section 4202 calculates a refund to 50,000 yen.

For example, when the program attribute 4023 is the program attribute 4023D indicating the drama and the capacity information 4026 indicates 3 GB, the refund calculation table 4204 shows that the drama corresponds to rank A and the refund calculating section 4202 calculates a refund to 10,000 yen.

For example, when the program attribute 4023 is the program attribute 4023F indicating “Ichiro Famous” and the capacity information 4026 indicates 25 GB, the refund calculation table 4204 shows that “Ichiro Famous” corresponds to rank C and the refund calculating section 4202 calculates a refund to 300,000 yen.

Thus, the refund calculating section 4202 calculates a fund, which should be paid back to a transmitting end identified by the identifier contained by the transmitting end information 4041, based on the capacity information 4026 contained in the transmitting end information 4041. Note that although in the example a refund is calculated using the capacity information 4026 as a parameter, the present invention is not limited to this. For example, a refund may be calculated using the allocation information 4025 as a parameter.

The refund calculating section 4202 outputs refund information 4042 to the transmitting section 4203 (S4103). The refund information 4042 contains the program attribute 4023 and a calculated refund. The transmitting section 4203 transmits the refund information 4042 to program attribute provider terminals 4300 corresponding to the program attribute 4023 (S4104).

For example, when the program attribute 4023 is the program attribute 4023A indicating company A, the transmitting section 4203 transmits the refund information 4042 to the program attribute provider terminal 4300 of company A. When the program attribute 4023 is the program attribute 4023B indicating company B, the transmitting section 4203 transmits the refund information 4042 to the program attribute provider terminal 4300 of company B. When the program attribute 4023 is the program attribute 4023D indicating the drama, the transmitting section 4203 transmits the refund information 4042 to the program attribute provider terminal 4300 of a company which produces the drama. When the program attribute 4023 is the program attribute 4023F indicating the name of the first famous person “Ichiro Famous”, the transmitting section 4203 transmits the refund information 4042 to the program attribute provider terminal 4300 of an agency, to which “Ichiro Famous” belongs.

Thus, according to the embodiment, the storage broadcast charging apparatus 4200 transmits the refund information 4042 which is calculated using the capacity information 4026 contained in the transmitting end information 4041 as a parameter, to the program attribute provider terminal 4300 possessed by a service provider.

Therefore, a charge for use of the program memory section 4102 can be paid back from a service (program attribute) provider based on the number of services (program attribute) which are assigned to the program memory section 4102 in the program receiving apparatus 4100.

As a result, the program receiving apparatus 4100 and the storage broadcast charging apparatus 4200 capable of receiving storage broadcast services, without a user bearing a large expense, can be provided.

### INDUSTRIAL APPLICABILITY

As described above, according to the present invention, a program receiving apparatus capable of reliably storing program contents which a user wants to store can be provided.

Further, according to the present invention, a program receiving apparatus and a storage broadcast charging apparatus capable of receiving storage broadcast services without a user bearing a large expense, can be provided.

1. (Amended) A program receiving apparatus, comprising:
a receiving section for receiving programs;
a program memory section having a multiple attribute memory region corresponding to both a first program attribute and a second program attribute indicating attributes of programs; and
a storage control section for storing a program having the first program attribute and the second program attribute out of the programs received by the receiving section, in the multiple attribute memory region corresponding to both the first program attribute and the second program attribute.

2. (Amended) A program receiving apparatus, comprising:
a receiving section for receiving programs and programs attributes indicating attributes of the programs;
a program memory section for holding memory regions corresponding to the program attributes and memorizing the programs in the memory regions;
a storage control section for storing the programs received by the receiving section in the memory regions in the program memory section corresponding to the program attributes received by the receiving region;
a memory region detecting section for detecting that the memory regions corresponding to the program attributes are allocated; and
an allocation information transmitting section for, when the memory region detecting section detects that a memory region corresponding to a specific program attribute is allocated, transmitting allocation information indicating the allocation.

3. (Amended) A program receiving apparatus, comprising:
a receiving section for receiving programs and programs attributes indicating attributes of the programs;
a program memory section for holding memory regions corresponding to the program attributes and memorizing the programs in the memory regions:
a storage control section for storing the programs received by the receiving section in the memory regions in the program memory section corresponding to the program attributes received by the receiving region;
a capacity managing section for managing capacities of the memory regions corresponding to the program attributes;
a capacity obtaining section for obtaining the capacities managed by the capacity managing section; and
a capacity information transmitting section for transmitting capacity information having a set of the program attributes and the capacities.

4. (Amended) A program receiving apparatus according to claim 2 or 3, further comprising:
a memory region setting section for setting the memory region of each of the program attributes in the program memory section.

5. A storage broadcast charging apparatus, comprising:
a transmitting end information receiving section for receiving transmitting end information having capacity information and a transmitting end identifier for identifying a transmitting end for the capacity information; and
a refund calculating section for calculating a fund which should be paid back to the transmitting end identified with the transmitting end identifier contained in the transmitting end information using the capacity information contained in the transmitting end information as a parameter.

6. (Added) A program receiving apparatus according to claim 1, further comprising a memory region setting section for setting the multiple attribute memory region corresponding to the first program attribute and the second program attribute in the program memory region.
